(19) United States
(12) Patent Application Publication
(10) Pub. No.: US 2011/0185365 A1
(43) Pub. Date: Jul. 28, 2011

(54) DATA PROCESSING SYSTEM, METHOD FOR PROCESSING DATA AND COMPUTER PROGRAM PRODUCT

(75) Inventors: Daniel Bauer, Birmensdorf (CH); Kristijan Dragicevic, Zurich (CH); Luis Garcés-Erice, Zurich (CH)

(73) Assignee: INTERNATIONAL BUSINESS MACHINES CORPORATION, Armonk, NY (US)

(21) Appl. No.: 13/015,718

(22) Filed: Jan. 28, 2011

(30) Foreign Application Priority Data
Jan. 28, 2010 (EP) 10151985.8

(51) Int. Cl. G06F 9/50

(52) U.S. Cl. 718/104

(57) ABSTRACT

A computer-implemented data processing system, computer-implemented method and computer program product for processing data. The system includes: a scheduler; a processor system; and at least one producer for executing a task. The scheduler is operable to allocate to the producer with respect to a scheme, a processing time of a processing resource of the processor system. The producer is operable to execute the task using said processor system during the allocated processing time.

### CROSS-REFERENCE TO RELATED APPLICATIONS

This application claims priority under 35 U.S.C. §119 to European Patent Application No. 10151985.8 filed Jan. 28, 2010, the entire contents of which are incorporated by reference herein.

### BACKGROUND OF THE INVENTION

1. Field of the Invention

The invention refers to a data processing system, a method for processing data and a computer program product.

2. Description of the Related Art

In known data processing systems, schedulers decide how a number of tasks are executed, according to some policy. The policy determines how the resources in a processing system are partitioned among the tasks to run the tasks. The scheduler is the active part in the system. The scheduler picks a task and performs the work associated with it, be it some code to be executed, an event to be dispatched, or some other job. Under certain circumstances, this way of processing data causes problems.

U.S. Pat. No. 7,412,532 describes a song and a scheduler supporting clip-based and stream-based scheduling of multimedia items generating several hours of schedule in advance. Having a multiple-channel capability, the scheduler uses as inputs the channel, associated play lists, associated quotation patterns for the channel and associated programming rules to produce a schedule of multimedia items for the channel. Initially, the scheduler produces a schedule for each channel of predetermined lengths; then it periodically revisits the channel to add more songs, keeping the schedule to the decided length. The scheduler uses a producer/consumer model for distributing work. Producer threads periodically scan the system for work to be done. When a producer thread encounters work to be done, e. g. adding to the schedule of a channel, the producer thread places a work request into a queue. Worker threads consume the work requests by fulfilling the requested work.

U.S. Pat. No. 7,500,241 B1 describes a method and apparatus for scheduling tasks. The patent describes a scheduler system for using a connection with a resource allocation system. A plurality of queues is provided for scheduling the delivery of tasks or events to a resource. Each of the provided queues may have a different threshold time, allowing the queues to be segmented according to the time values of the included tasks.

### SUMMARY OF THE INVENTION

According to one aspect of the present invention, a computer-implemented data processing system is provided that includes: a scheduler; a processor system; and at least one producer for executing a task. The scheduler is operable to allocate to the producer with respect to a scheme, a processing time of a processing resource of the processor system. The producer is operable to execute the task using said processor system during the allocated processing time.

According to another aspect of the present invention, a computer-implemented method is provided for processing data with a processor system, a producer and a scheduler. The method includes: allocating to the producer with respect to a scheme, a processing time of a processing resource of the processor system during a time period, where the schedule performs the allocation; and executing a task using the processor system during the allocated processing time within the time period, where the producer performs the execution.

According to yet another aspect of the present invention, a computer program product is provided that includes a computer-usable medium having a computer-usable program code for processing data, which when executed on a computer system, causes the computer to carry out the steps of the method.

### BRIEF DESCRIPTION OF THE DRAWINGS

FIG. 1 depicts a schematic view of a data processing system according to an embodiment of the present invention;

FIG. 2 depicts a time period with allocated processing times according to an embodiment of the present invention;

FIG. 3 depicts a schematic program flow of the data processing method according to an embodiment of the present invention;

FIG. 4 depicts a further embodiment of the data processing method;

FIG. 5 depicts a computer program product according to an embodiment of the present invention.

### DETAILED DESCRIPTION OF THE PREFERRED EMBODIMENTS

According to an embodiment of the present invention, a computer-implemented data processing system is provided that includes: a scheduler; a processor system; and at least one producer for executing a task. The scheduler is operable to allocate to the producer with respect to a scheme, a processing time of a processing resource of the processor system. The producer is operable to execute the task using said processor system during the allocated processing time.

The scheduler can be used for allocating a resource to a producer, where the task can be executed by the producer itself. As such, the producer is not isolated from the execution of the task. The producer of the task can keep control of how the task is actually executed. The scheduler can be used for partitioning the available resource to several producers in order to ensure that all tasks are executed without conflict. Furthermore, no queues are used for executing tasks.

Referring to FIG. 1, the drawing depicts in a schematic view a data processing system 1 which includes a scheduler 2, a first, a second and a third producer 3, 4, 5, a processor system 6 and a data memory 9. Furthermore, the data processing system 1 includes an input 10 and an output 11 for receiving and/or sending data and/or instructions. Furthermore, a clock 13 and a timer 12 are disposed. The timer 12 is connected with the scheduler 2.

The processor system 6 includes, in the shown embodiment of the present invention, a first central processing unit 7 and a second central processing unit 8. The processor system 6 is connected with the data memory 9, the scheduler 2 and the first, the second and the third producer 3, 4, 5.

The scheduler 2 and the first, the second and the third producer 3, 4, 5 can be utilized as electric circuits and/or as software functions running on a third processor 14. The scheduler 2 is a passive scheduler which can be used for a multiple processor system 6 having two or more processors 7, 8. The scheduler 2 allocates a processing time of the processor system 6 to the producers to execute tasks. The processing time is allocated by the scheduler to produce a constant flow of work in the processor system 6. The scheduler 2 may not execute tasks of the producer and may not perform the desired processor resources allocation by controlling the execution of the tasks, stopping them or allowing them to continue.

If a producer 3, 4, 5 wants to execute a task, then the producer 3, 4, 5 contacts the scheduler 2 asking for a processing resource of the processor system 6 to execute the task. The scheduler 2 checks whether there is a free available resource of processing data by means of the processor system 6. If there is a free available resource for processing data on the processor system 6, then the scheduler 2 allocates the requested resource of the processor system 6 to the producer 3, 4, 5.

In the shown embodiment of the present invention, the processing resource is partitioned as a fraction of time within a predetermined time period which can be used by the producer to execute the task by using the processor system 6. Therefore, the producers keep control of how their tasks are actually executed on the processor system 6. If the processor system 6 includes several processors 7, 8, as it is the case in the shown embodiment of the present invention, then the scheduler 2 distributes the processing resources of the two processors 7, 8 to the producers 3, 4, 5 to execute at least one task. Depending on the embodiment, each producer 3, 4, 5 can have a queue of tasks to be executed by the producer 3, 4, 5. Furthermore, the number of tasks to be executed by the producer 3, 4, 5 can change from time to time.

The scheduler 2 can allocate the available processing resource of the processor system 6 according to a scheme. The scheme can depend on the number of active producers and/or a priority of the producers and/or a priority of the tasks of the producers. The scheme can change, but it can also be fixed and have a simple structure, e.g. a percentage of the processing resource of the processor system 6 can be allocated according to the number of tasks or the number of producers or the amount of tasks to be executed by a producer.

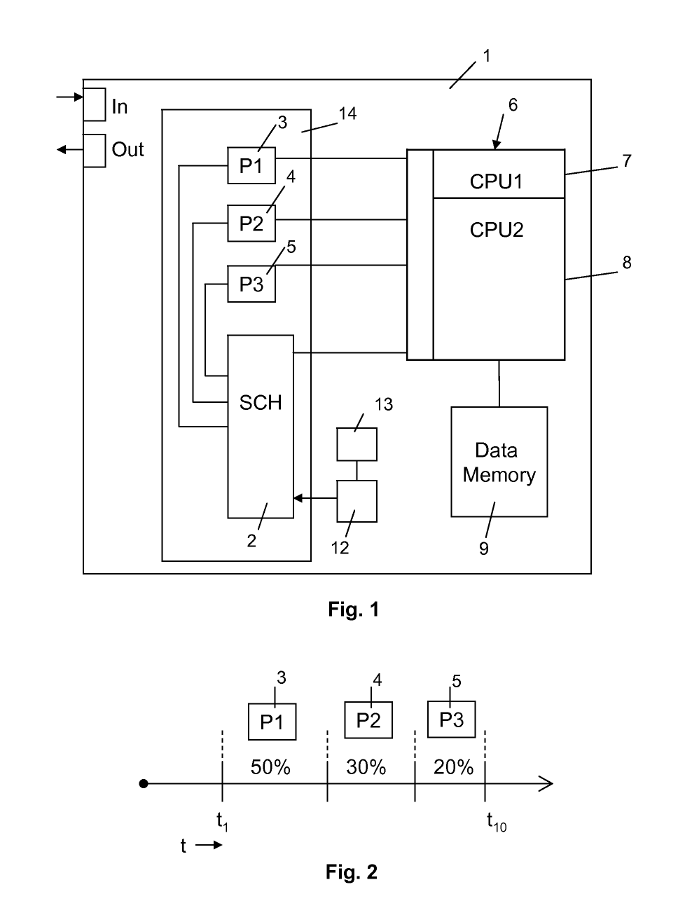

FIG. 2 shows a simple example for the allocation of processing time of the processor system 6 to the producers 3, 4, 5 which is repeated for a time period. The time period starts at a first time t1 and lasts until a second time t10. The first 50% of the processing time of the time period in this example is allocated to the first producer 3. The following 30% of the processing time of the time period is allocated to the second producer 4. The last 20% of the processing time of the time period is allocated to the third producer 5. The example in FIG. 2 can refer to a processing time of a computer system 6 having one processor 7. However, the same allocation can also be used for the processing resource of a processor system 6 having several processors 7, 8, where the allocated processing time of the processor system 6 for a producer can be allocated to one processor or subdivided in time slots to several processors 7, 8.

The described method allows the scheduler to partition the processor resource of the processor system 6 with multiple processors among a number of tasks, without the producers of the tasks having to give up control of the task execution. This is especially useful in a system where the producer wants the task to be executed synchronously to the tasks of other producers. By using a one-processor system, the tasks are executed synchronously referring to the predetermined time period and not actually in parallel at the same time. However, after a period of time, the tasks of the different producers will be executed. This can lead to a number of advantages for the producers. The producer recognizes at all moments the progress of the execution of the task and when the task is finished. The producer does not have to be concerned about how the scheduler is using the resource for the task.

In the shown embodiment of the present invention, the processing resource of the processor system 6 is allocated as shares of processing time. These shares are valid over a certain time period which is short enough for tasks to be processed by the producer within reasonable time limits. For example, the time period can be 100 ms, meaning that if the execution of a task gets 10% share of processing time during the time period, the task of another producer can be finished within 10 ms and the next task can be processed in at most 90 ms.

The producers 3, 4, 5 can produce at a constant rate new tasks which should be executed by the producers. The scheduler 2 provides the producers with an execution environment where the producers 3, 4, 5 can perform the jobs associated with the tasks while the partition of the resource of the processor system 6 is effectively used.

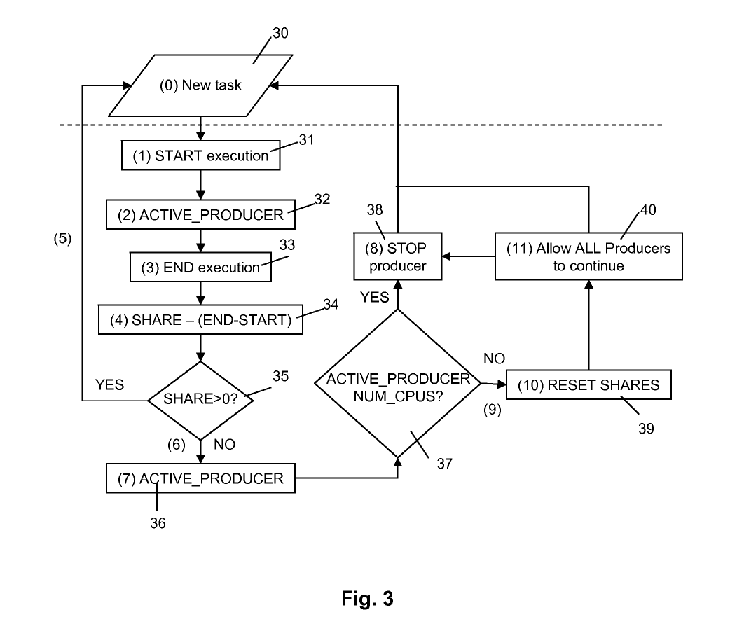

FIG. 3 depicts a schematic program flow of the data processing method. Each producer 3, 4, 5 which intends to execute a task on the processor system 6 registers with the scheduler 2 its intention to execute a task with some share of the processor resource of the processor system 6 over a time period. FIG. 3 depicts in a first step 30 the situation when the first producer 3 generates a new task and intends to execute the task and therefore requests the scheduler 2 to allocate a processing resource of the processor system 6 to the first producer 3. The scheduler 2 checks whether a free processing resource is available that is equal to or larger than the share that is requested by the first producer 3. If there is enough free processing resource, then the scheduler 2 allocates the requested share of the processor resource i.e. a processing time to the requesting first producer 3. Then, the scheduler registers that there is one more producer using the processor system 6. If there is not enough free processing resource, then the first producer 3 has to wait until enough free processing resource is available.

Depending on the situation, there might be several active producers 3, 4, 5 which are registered with the scheduler 2 and have allocated shares of the processing resource, i. e. shares of processing time.

In a following second step 31 the first producer 3 starts executing the task within the allocated processing time. In a third step 32 the first producer 3 executes the task and in a fourth step 33 the first producer 3 finishes the execution of the task. In a following fifth step 34 the first processor 3 checks whether there is still some time of the allocated processing time available for the first producer 3. In a following comparison step 35 the first producer 3 checks whether there is still some time of the allocated processing time available. If there is still some share of the processing time available, then the first producer 3 goes back to the first step 30, produces a further task and enters the second step 31 executing the further task. If at the comparison step 35, no further share of the allocated processing time is available for the first producer 3, then the first producer 3 gives the information that it has finished executing the processing of the task to the scheduler in the following step 36. The scheduler stores that there in one active producer less.

Then the first producer 3 checks with the scheduler 2 to determine what to do next. The scheduler 2 first notes that there is one active producer less in the processor system 6. In a following eighth step 37, the scheduler 2 or the first producer 3 checks whether there are more active producers than numbers of processors 7, 8. If there are more active producers than numbers of processors, then in a following ninth step 38 the first producer 3 stops. After the ninth step 38, the program is referred back to the first step 30.

However, if the check at the eighth step 37 shows that there are not more active producers than available numbers of processors 7, 8, then the program is referred to a tenth step 39. In the tenth step 39, the first producer 3 resets the allocated shares of all the active producers to their original values that are determined by the scheduler 2. Then, in an eleventh step 40, a new time period is started and all registered producers continue executing new tasks, effectively using all the processor resources as allocated by the scheduler 2. All active producers which means all producers that are registered with the scheduler 2 are allowed to continue producing tasks and to execute the tasks according to the original values of the allocated processing times of the processor system 6.

Note that the scheduler 2, without any active part of its own, is work-conserving: for example, even if a producer has allocated only a fraction of the processor resources, if it is the only active producer after the eighth and the tenth step 37, 39, its share will be reset and the only producer can continue executing a new task, effectively using all the processor resources.

It can be the case that the producer that executes the tenth step 39 and the eleventh step 40 fails due to some application error, or because the producer does not conform to the constant task production rate. In that case, the failed producer cannot allow all the other producers that are stopped to continue operating, which would result in the system not performing any work.

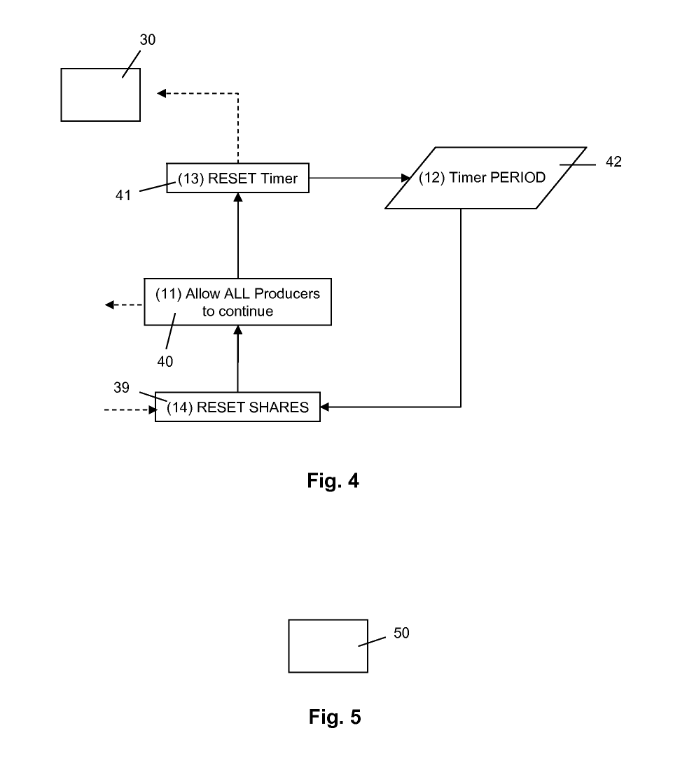

Therefore, in a further embodiment of the present invention the method of FIG. 3 is expanded as shown in FIG. 4 and, in order to avoid this situation, a timer 12 is applied which is shown in FIG. 1. The timer 12 is used after the eleventh process step 40 before returning to the first process step 30. The timer 12 can be utilized as a hardware unit or a software program. After the eleventh step 40 the timer 12 is reset in a twelfth step 41, the program is returned to the first step 30. The timer 12 has the function to count from a zero value up to a predetermined value for every time count that is provided by the clock 13. This function is schematically shown in a 13^{th} step 42.

If the timer reaches the predetermined value, then the timer causes the execution of the tenth step 39, resetting the located shares of the allocated processing resources of the producers 3, 4, 5. Therefore, the timer 12 assures a reset at least at the end of every predetermined second time period of the allocated processing times of all active producers to the original values that were allocated by the scheduler 2. After the reset a new time period starts and all producers continue executing tasks. Note that in normal circumstances, the timer 12 should not activate the reset because resetting the allocated processing times of the producers is usually performed by a producer and the timer is usually reset at the 12^{th} step 41.

Different methods can be implemented for different embodiments of the present invention. One method is using mutual exclusion, for example a lock, to avoid inconsistencies among the tasks by protecting critical data structures storing information such as the time shares of the tasks. Conflicts can occur between the timer 12 that is used to reset the allocated processing times of all producers and the producers that update their allocated processing times. Another method is using lock-free methods to update the allocated processing times and to implement the resets of the allocated processing times. In that case, an epoch can be introduced to reset the allocated processing times if necessary. The timer takes care of increasing the epoch counter every period. Every time a producer detects an increment in the epoch counter, the producer knows that it has to reset its allocated processing time and to start executing a task.

In the following, an example is described that assumes a system with three active producers 3, 4, 5, where a single first processor 7 is partitioned among them by the scheduler 2 with shares of resources of 10% of the processing time of the first processor 7 during the time period for the first producer 3, 40% of the processing time of the first processor 7 during the time period for the second producer 4 and 50% of the processing time of the first processor 7 during the time period for the third producer 5. These shares are guaranteed over a period of 100 ms, which means that in each period, the first producer 3 has the right for 10 ms, the second producer 4 has the right for 40 ms and the third producer 5 has the right for 50 ms to execute tasks.

Assume that during the first 20 ms, the second producer 4 has performed during 10 ms executing a task, and the first producer 3 has performed executing a task during another 10 ms. The first producer 3 has terminated its allocated processing time for the current time period, but recognizes that there is still an active second producer 4. Thus, the first producer 3 stops. Now, the third producer 5 performs during 30 ms executing a task, and then, the second producer 4 performs executing a task during another 30 ms. Then, the second producer 4 has consumed its entire 40 ms of processing time, but recognizes that there is still one active third producer 5. So, the second producer 4 stops. The third producer 5 completes its last 20 ms of performing executing a task. Then, the third producer 5 has consumed all its share of processing resource, but recognizes that there is no other active producer. Then, the third producer 3 resets the shares of all producers which means that the first, the second and the third producer 3, 4, 5 get the originally allocated 10%, 40% and 50% of the processing resource and a new time period is started. The distribution of the available processing time is only carried out by the scheduler 2.

Now, assume that the third producer 5 has no work to do during the following time period. During the first 20 ms, the second producer 4 and the first producer 3 each perform executing tasks for a time of 10 ms, and as before, the first producer 3 stops. Then, the second producer 4 performs execution of a task for further 30 ms, where no other producer is active. After finishing the allocated 40% of the available processing time during the time period which means 40 ms, then the second producer 4 resets the shares of the first, the second and the third producer 3, 4, 5 to the original values of 10%, 40% and 50% of the time period. Then, a new time period is started. The same pattern is repeated during the next 50 ms. At the end, the first producer 3 has consumed 20% of the processing time, and the second producer 4 has consumed 80% of the available processing time. Thus, the scheduler 2 is work-conserving because each producer gets its share, and if some of them do not use it, other producers can use it.

The scheduler 2 changes the values of the allocated processing time of the producers if a new producer request for processing time or an active producer instructs the scheduler to stop using the processor system 6. The allocated shares of the processing resource, i.e. the processing time of the processor resource 6 is stored in the data memory.

Depending on the embodiment of the present invention, a task can be e.g., processing a message or sending a message. Additionally, depending on the embodiment, a producer can be e.g. a publisher in a publish/subscribe system.

The described data processing system and method for processing data can be part of a message system, e.g. a real-time java message system. The system and the method can also be implemented in another computer programming language than java.

Further embodiments of the present invention refer to a data processing system and a method for processing data, where a producer which finishes a task before the end of its processing time starts executing another task. This can allow the producer to use the entire processing time although a task has been finished. Therefore, more data can be processed during the processing time.

Other embodiments of the present invention refer to a data processing system and a data processing method, where the scheduler allocates the resource of the processor system to at least one producer after a predetermined time period. This feature allows resetting the data processing system and the method for processing data to prohibit a malfunction of the data processing system or the processing of data. There might be the situation that a producer incorrectly executes a task and thereby prevents other producers from executing their tasks. The proposed features can avoid blocking the entire system for a longer period of time.

Further embodiments of the present invention refer to a data processing system and a method for processing data, where the scheme depends on a number of producers and/or a priority of the producers and/or a priority of tasks of the producers. The proposed scheme can allow the scheduler to allocate the available resource for executing the tasks effectively.

Still further embodiments of the present invention refer to a producer and a corresponding method which resets the allocated processing times of the producers before the end of the time period if all producers have finished executing their tasks within the allocated processing time and before the end of the time period. Accordingly, if there is a free resource within the time period, the allocated processing times of the producers are reset and the free time within the time period can be used by other producers starting a new time period. Therefore, a higher efficiency of the data processing system and the data processing method can be attained.

Other embodiments of the data processing system and the data processing method according to the present invention refer to a scheduler which allocates to a new producer a requested resource if there is an available resource of the processing system. Thus, it is not necessary for the new producer to wait until the end of the time period, but the producer can start executing its task during any time if there is a free available resource of the processor system.

Further embodiments of the present invention refer to a data processing system and a data processing method, where a timer is used that provides for resetting the allocated processing times of the producers within a predetermined further time period. This embodiment can allow avoiding a blocking of the data processing system and the data processing method for a longer time period in the case of a faulty function of a producer.

A further embodiment of the data processing system according to the present invention refers to a processor system having at least two processors. The described data processing system and the described data processing method can use multiple processors which provide data processing resources. The scheduler partitions and allocates the data processing resources of the processors to the producers. Therefore, it is possible to execute tasks in parallel in real time on different processors. This can enhance the velocity of the data processing.

A further embodiment of the present invention refers to a producer that resets the allocated processing time of all producers after the producer has finished its task within the allocated time, and if there is at least an equal number or more processors than producers available. This can increase the amount of processed data.

A further embodiment of the present invention refers to a computer program product comprising a computer-usable medium having a computer-usable program code for processing data according to the described method. FIG. 5 depicts a computer program product 50, for example a DVD that includes a computer-usable medium having a computer-usable program code for processing data according to the method as explained with respect to the FIGS. 3 and 4.

What is claimed is:

1. A computer-implemented data processing system comprising:
a scheduler;
a processor system; and
at least one producer for executing a task,
wherein said scheduler is operable to allocate to said producer with respect to a scheme, a processing time of a processing resource of said processor system, and
wherein said producer is operable to execute said task using said processor system during said allocated processing time.

2. The data processing system according to claim 1, wherein said producer is operable to start executing another task if said producer has finished a task before the end of said allocated processing time.

3. The data processing system according to claim 1, wherein said processing system comprises:
a timer that is operable to start resetting, after a predetermined time period, the processing time of said producer if said allocated processing time is not reset within said predetermined time period.

4. The data processing system according to claim 2, wherein said processing system comprises:
a timer that is operable to start resetting, after a predetermined time period, the processing time of said producer if said allocated processing time is not reset within said predetermined time period.

5. The data processing system according to claim 1, wherein said producer is operable to reset, before the end of a time period, said allocated processing time of all said producers if all said producers finished executing said respective tasks before the end of said time period.

6. The data processing system according to claim 1, wherein a new producer is operable to register with said scheduler to execute a task with a predetermined processing resource, wherein said scheduler is operable to grant to said producer said requested processing resource of said processor system as a processing time during a time period if enough free processing resource of said processor system is available and said new producer is operable to start executing said task during said allocated processing time of said processor system.

7. The data processing system according to claim 1, wherein said processor system comprises at least two processors.

8. The data processing system according to claim 5, wherein said producer is operable to reset said allocated processing times of all other said producers after said producer has finished resetting said allocated processing time and if there are more processors than active producers.

9. The data processing system according to claim 7, wherein said producer is operable to reset said allocated processing times of all other said producers after said producer has finished resetting said allocated processing time and if there are more processors than active producers.

10. The data processing system according to claim 1, wherein said scheduler is a hardware unit or a computer program and said producer is a hardware unit or a computer program.

11. A computer-implemented method of processing data with a processor system, a producer and a scheduler comprising:
allocating to said producer with respect to a scheme, a processing time of a processing resource of said processor system during a time period, wherein said schedule performs said allocation; and
executing a task using said processor system during said allocated processing time within said time period, wherein said producer performs said execution.

12. The method according to claim 11, further comprising:
executing another task if said producer finishes said task before the end of said allocated processing time, wherein said producer performs said execution of said another task.

13. The method according to claim 11, further comprising:
resetting said allocated processing time of said producer to the original value after a predetermined time period; and
starting a new time period.

14. The method according to claim 12, further comprising:
resetting said allocated processing time of said producer to the original value after a predetermined time period; and
starting a new time period.

15. The method according to claim 11, wherein said producer resets, before the end of said processing time period, allocated processing times of all other producers to respective original values if all other said producers finish executing respective tasks before the end of a time period.

16. The method according to claim 11, wherein a new producer registers with said scheduler to execute a task with a predetermined processing resource of said processor system, wherein said scheduler grants to said producer said requested processing resource if enough free processing resource of said processor system is available and said new producer starts executing said task during said allocated processing time within said time period.

17. The method according to claim 11, wherein said producer resets allocated processing times of all other producers if all other said producers finished respective tasks and if there are more processor systems than producers.

18. The method according to claim 16, wherein said producer resets allocated processing times of all other producers if all other said producers finished respective tasks and if there are more processor systems than producers.

19. A computer program product comprising a computer-usable medium having a computer-usable program code for processing data, which when executed on a computer system, causes the computer to carry out the steps of a computer implemented method according to claim 11.
